(19) United States
(12) Patent Application Publication
(10) Pub. No.: US 2025/0350343 A1
(43) Pub. Date: Nov. 13, 2025

(54) Methods And Apparatus For Hierarchical Quasi-Colocation Structure In Mobile Communications

(71) Applicant: MediaTek Inc., Hsinchu City (TW)

(72) Inventors: Cheng-Rung Tsai, Hsinchu City (TW); Din-Hwa Huang, Hsinchu City (TW); Chia-Hao Yu, Hsinchu City (TW); Yi-Ru Chen, Hsinchu City (TW)

(21) Appl. No.: 19/190,459

(22) Filed: Apr. 25, 2025

Related U.S. Application Data
(60) Provisional application No. 63/645,223, filed on May 10, 2024.

(51) Int. Cl. H04B 7/06; H04L 5/00; H04W 64/00

(52) U.S. Cl. CPC H04B 7/06968; H04B 7/0626; H04L 5/0048; H04W 64/003

(57) ABSTRACT

Various solutions for hierarchical quasi-colocation (QCL) structure with respect to user equipment (UE) and network apparatus in mobile communications are described. The UE may receive a transmission reception point reference signal (TRP-RS). The UE may receive a first configuration indicating that the TRP-RS is associated with a second reference signal with a first QCL-type. The UE may transmit or receive the second reference signal based on at least one parameter determined according to the first QCL-type.

### CROSS REFERENCE TO RELATED PATENT APPLICATION(S)

The present disclosure is part of a non-provisional application claiming the priority benefit of U.S. Patent Application No. 63/645,223, filed 10 May 2024, the content of which herein being incorporated by reference in its entirety.

### TECHNICAL FIELD

The present disclosure is generally related to mobile communications and, more particularly, to hierarchical quasi-colocation (QCL) structure with respect to user equipment (UE) and network apparatus in mobile communications.

### BACKGROUND

Unless otherwise indicated herein, approaches described in this section are not prior art to the claims listed below and are not admitted as prior art by inclusion in this section.

Quasi-colocation (QCL) in 5G New Radio (NR) refers to a scenario where a UE can assume that different antenna ports have certain channel properties in common. These properties include Doppler spread, Doppler shift, average delay, delay spread, etc. The QCL framework allows the UE to reuse channel estimation results obtained from a source reference signal for the reception of another signal or channel that is declared as QCL with the first. This reduces the UE's receiver complexity and power consumption.

However, the current developed QCL framework employs a comprehensive QCL relationship between the source and target reference signals, which results in complicated QCL updates and indications. Therefore, a novel QCL framework is needed to mitigate these issues.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to hierarchical quasi-colocation (QCL) structure with respect to user equipment (UE) and network apparatus in mobile communications.

In one aspect, a method may involve an apparatus receiving a transmission reception point reference signal (TRP-RS). The method may also involve the apparatus receiving a first configuration indicating that the TRP-RS is associated with a second reference signal with a first QCL-type. The method may further involve the apparatus transmitting or receiving the second reference signal based on at least one parameter determined according to the first QCL-type.

In another aspect, an apparatus may comprise a transceiver which, during operation, wirelessly communicates with a network. The apparatus may also comprise a processor communicatively coupled to the transceiver. The processor, during operation, may perform operations comprising receiving a TRP-RS via the transceiver. The processor, during operation, may also perform operations comprising receiving, via the transceiver, a first configuration indicating that the TRP-RS is associated with a second reference signal with a first QCL-type. The processor, during operation, may further perform operations comprising transmitting or receiving, via the transceiver, the second reference signal based on at least one parameter determined according to the first QCL-type.

In yet another aspect, a method may involve a network node transmitting a TRP-RS to a UE. The method may also involve the network node transmitting a first configuration indicating that the TRP-RS is associated with a second reference signal with a first QCL-type to the UE.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting a hierarchical quasi-colocation (QCL) structure in accordance with implementations of the present disclosure.

FIG. 3 is a diagram depicting a non-hierarchical QCL structure.

FIG. 4 is a diagram depicting another hierarchical QCL structure in accordance with implementations of the present disclosure.

FIG. 5 is a diagram depicting an example scenario under schemes in accordance with implementations of the present disclosure.

FIG. 6 is a block diagram of an example communication system in accordance with an implementation of the present disclosure.

FIG. 7 is a flowchart of an example process in accordance with an implementation of the present disclosure.

FIG. 8 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to hierarchical quasi-colocation (QCL) structure with respect to user equipment (UE) and network apparatus in mobile communications. According to the present disclosure, a number of possible solutions may be implemented separately or jointly. That is, although these possible solutions may be described below separately, two or more of these possible solutions may be implemented in one combination or another.

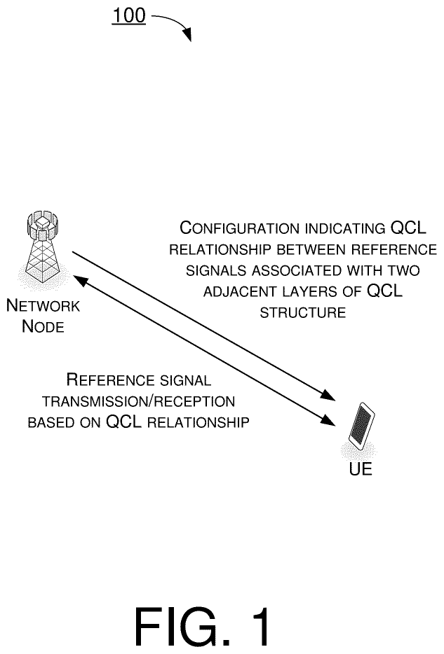

FIG. 1 illustrates an example scenario 100 under schemes in accordance with implementations of the present disclosure. Scenario 100 involves at least one network node and a UE, which may be a part of a wireless communication network (e.g., an LTE network, a 5G/NR network, an IoT network or a 6G network). Scenario 100 illustrates the network framework. The UE may connect to the network side. The network side may comprise one or more network nodes.

In some embodiments, the network node may transmit one or more reference signals (RSs) to the UE. Further, the network node may transmit a configuration indicating a QCL relationship between reference signals (e.g., a reference signal is associated with another reference signal with certain QCL-type). Specifically, the reference signals with the QCL relationship indicated by the configuration are associated with two adjacent layers of a QCL structure. In other words, scenario 100 supports a hierarchical QCL structure, where the UE may receive a source reference signal from the network node and a configuration indicating the QCL relationship between the source reference signal and a target reference signal. The source and target reference signals reside in two immediately succeeding layers of the QCL structure due to its hierarchical structure. Then, based on this QCL relationship, the UE may determine at least one parameter to facilitate the reception or transmission of the target reference signal.

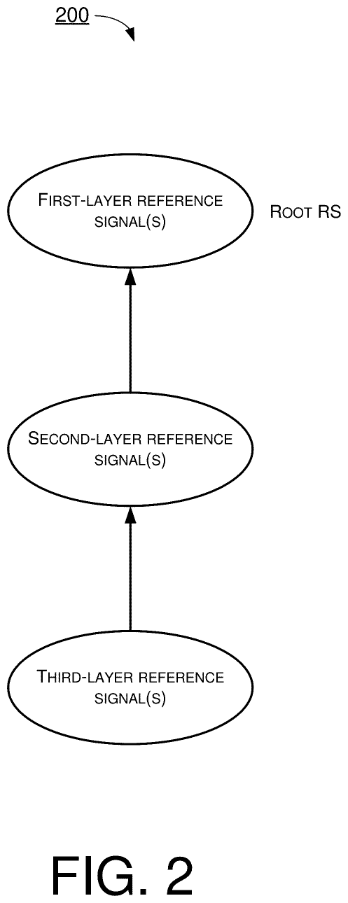

FIG. 2 is a diagram depicting a hierarchical QCL structure 200 in accordance with implementations of the present disclosure. As shown in FIG. 2, the hierarchical QCL structure 200 includes three layers. The reference signal(s) associated with the first layer of the hierarchical QCL structure 200 are referred to as the first-layer reference signal(s); similarly, the reference signal(s) associated with the second and third layers are referred to as the second-layer and third-layer reference signal(s), respectively. In the hierarchical QCL structure 200, each arrow originates from a target reference signal and terminates at its source reference signal. A first-layer reference signal may be the source reference signal for one or more second-layer reference signals. Furthermore, a second-layer reference signal may be the source reference signal for one or more third-layer reference signals. In one embodiment, there is no cross-level QCL relationship in the hierarchical QCL structure 200. That is, the first-layer reference signal will not be the source reference signal for any third-layer reference signals.

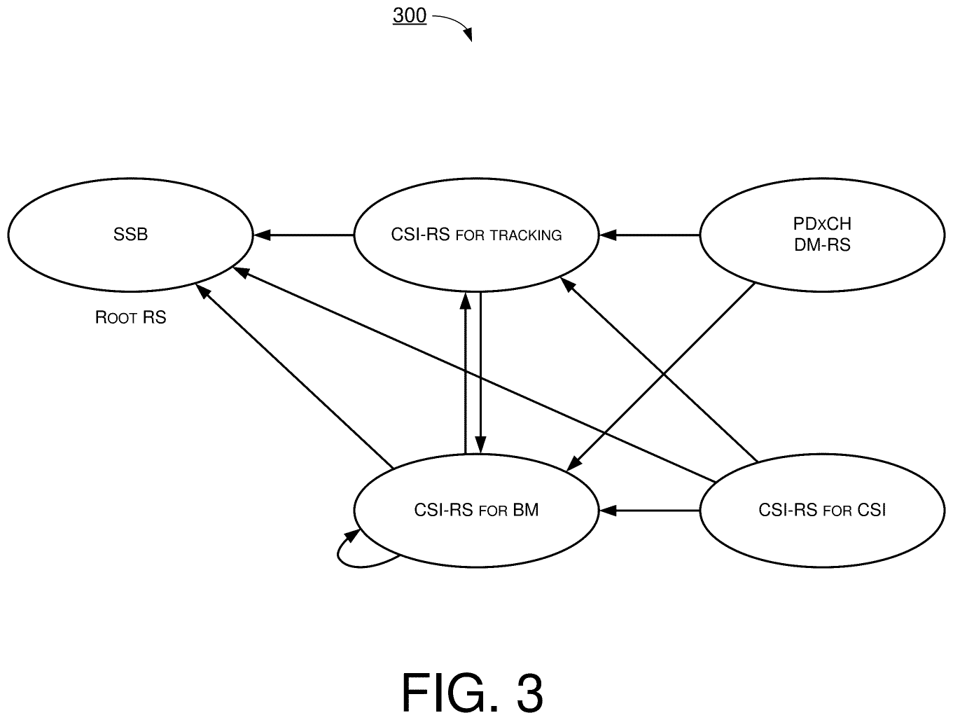

FIG. 3 is a diagram depicting a non-hierarchical QCL structure 300, which involves the reference signals such as a synchronization signal block (SSB), a channel state information reference signal (CSI-RS) for tracking, a CSI-RS for beam measurement (BM), a physical downlink shared channel (PDSCH) demodulation reference signal (DM-RS), a physical downlink control channel (PDCCH) DM-RS, and a CSI-RS for CSI. Each arrow in the non-hierarchical QCL structure 300 points from a target reference signal to a source reference signal. Compared with the hierarchical QCL structure 200, the non-hierarchical QCL structure 300 employs a comprehensive QCL relationship between the source and target reference signals, leading to complicated QCL updates and indications.

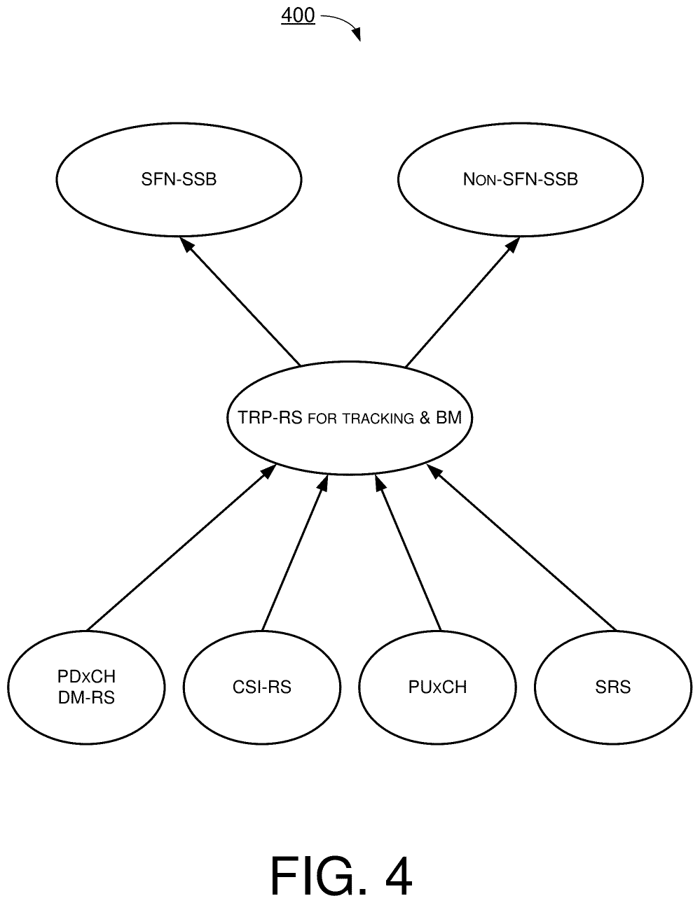

FIG. 4 is a diagram depicting another hierarchical QCL structure 400 in accordance with implementations of the present disclosure. In the hierarchical QCL structure 400, the reference signals may include a single frequency network (SFN)-SSB, a non-SFN-SSB, a transmission reception point reference signal (TRP-RS), a PDSCH DM-RS, a PDCCH DM-RS, a CSI-RS, a physical uplink shared channel (PUSCH), a physical uplink control channel (PUCCH), and a sounding reference signal (SRS). Specifically, the SFN-SSB and the non-SFN-SSB are the first-layer reference signals, the TRP-RS is the second-layer reference signal, and the PDSCH/PDCCH DM-RS (i.e., PDxCH DM-RS), the CSI-RS, the PUSCH/PUCCH (i.e., PUxCH), and the SRS are the third-layer reference signals. In the hierarchical QCL structure 400, each arrow represents a QCL relationship, originating from a target reference signal and pointing towards its source reference signal. That is, the TRP-RS may be the source reference signal of the PDxCH DM-RS, CSI-RS, PUxCH, or SRS. The SSB (either SFN-SSB or non-SFN-SSB) may be the source reference signal of the TRP-RS.

Based on the hierarchical QCL structure 400, the parameters for receiving or transmitting the PDxCH DM-RS, CSI-RS, PUxCH, and SRS are determined by a network configuration that associates the TRP-RS with the target reference signal with a certain QCL-type. Furthermore, the parameters for receiving the TRP-RS are determined based on the hierarchical QCL structure 400 by another network configuration that associates the SSB (either SFN-SSB or non-SFN-SSB) with the TRP-RS with a certain QCL-type.

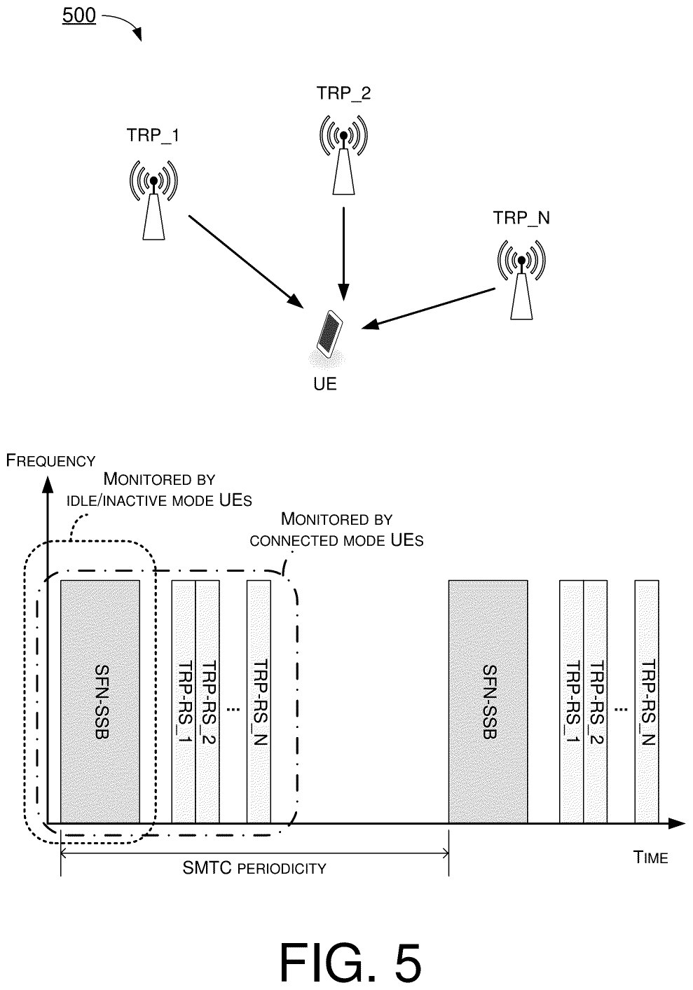

The SFN-SSB (also referred to as I-SSB) is the identical SSB broadcast synchronously by multiple TRPs within a single base station (e.g., gNB) or cell. This synchronized transmission facilitates coarse time and frequency (T/F) tracking for the UE. Notably, UEs in an idle/inactive mode may monitor the SFN-SSB for tasks such as system information acquisition and idle mode mobility procedures. The TRP-RS (also referred to as M-SSB), is transmitted by each individual TRP in addition to the common SSB. The TRP-RS is TRP-specific and is designed as an always-on signal. Its primary purpose is to enable fine T/F tracking for UEs. The TRP-RS also plays a crucial role in connected mode mobility, allowing UEs to evaluate the signal quality of specific TRPs for potential handover scenarios. Consequently, UEs operating in the connected mode may monitor both the SFN-SSB and the TRP-RS. As shown in scenario 500 of FIG. 5, TRP_1, TRP_2, and TRP_N (where N is a positive integer) are associated with one base station and may transmit the same SFN-SSB. Each of the TRP_1, TRP_2, and TRP_N may further transmit TRP-RS_1, TRP-RS_2, and TRP-RS_N. The SFN-SSB may be used for base station/cell-level measurements, while the TRP-RS may be used for TRP-level measurements. When the UE is in the idle/inactive mode, it may monitor the SFN-SSB transmitted from TRP_1, TRP_2, and TRP_N based on the SSB measurement timing configuration (SMTC) periodicity. When the UE is in the connected mode, it may monitor both the SFN-SSB and the TRP-RS_1, TRP-RS_2, and TRP-RS_N based on the SMTC periodicity.

Referring back to FIG. 4, in one embodiment, the SFN-SSB in the hierarchical QCL structure 400 may be transmitted by a base station/cell/TRP operating in frequency range (FR) 1 or FR3, while the non-SFN-SSB may be transmitted by a base station/cell/TRP operating in FR2. Furthermore, the TRP-RS is, for example, for fine T/F tracking and/or BM (spatial filtering parameter). That is, T/F tracking and/or BM share the same reference signal resource. By utilizing a single reference signal resource for both tracking and BM, the reference signal configuration and QCL structure can be further simplified. The CSI-RS may be a CSI-RS for channel acquisition or a zero power (ZP) CSI-RS for rate-matching. It should be noted that the hierarchical QCL structure 400 may include other reference signals, such as the TRP-RS for layer 1 (L1)/L2 or L3 mobility, or CSI-interference measurement (IM).

In one embodiment, the network node may utilize a transmission configuration indicator (TCI) framework to indicate the QCL relationship in the hierarchical QCL structure 400. Specifically, a TCI state may indicate the source reference signal and the corresponding QCL-type. In the present disclosure, the QCL-type may be any or a combination of QCL-Type A, QCL-Type B, QCL-Type C, QCL-Type D, and spatial relation. Each QCL-type is associated with one or more parameters of the radio channel properties. For example, QCL-Type A is associated with the parameters of Doppler shift, Doppler spread, average delay, and delay spread. QCL-Type B is associated with the parameters of Doppler shift and Doppler spread. QCL-Type C is associated with the parameters of average delay and delay spread. QCL-Type D is associated with the parameters of spatial reception (Rx) parameter. Spatial relation is associated with the parameters for uplink (UL) transmission. In one example, the network node may utilize a combination of radio resource control (RRC) signaling, medium access control-control element (MAC-CE) signaling and PDCCH to inform the UE of the QCL relationship indicated by the TCI state. The configuration of the TCI states associated with the hierarchical QCL structure 400 is as follows, the phrase ‘when applicable’ in the subsequent configurations may refer to scenarios where the UE is operating in a high frequency band.

For the DM-RS of PDxCH, the UE shall expect that a TCI state indicates one of the following QCL-type(s):
‘QCL-Type A’ with a TRP-RS resource and, when applicable, ‘QCL-Type D’ with the same TRP-RS resource, or
‘QCL-Type B’ with a TRP-RS resource and, when applicable, ‘QCL-Type D’ with the same TRP-RS resource.

For a CSI-RS resource, the UE shall expect that a TCI state indicates one of the following QCL-type(s):
‘QCL-Type A’ with a TRP-RS resource and, when applicable, ‘QCL-Type D’ with the same TRP-RS resource, or
‘QCL-Type B’ with a TRP-RS resource and, when applicable, ‘QCL-Type D’ with the same TRP-RS resource.

For the PUxCH, the UE shall expect that a TCI state indicates one of the following QCL-type(s):
‘QCL-Type A’ with a TRP-RS resource and, when applicable, ‘QCL-Type D’ with the same TRP-RS resource,
‘QCL-Type B’ with a TRP-RS resource and, when applicable, ‘QCL-Type D’ with the same TRP-RS resource, or
‘Spatial relation’ with a TRP-RS resource when applicable.

For a SRS resource, the UE shall expect that a TCI state indicates one of the following QCL-type(s):
‘QCL-Type A’ with a TRP-RS resource and, when applicable, ‘QCL-Type D’ with the same TRP-RS resource,
‘QCL-Type B’ with a TRP-RS resource and, when applicable, ‘QCL-Type D’ with the same TRP-RS resource, or
‘Spatial relation’ with a TRP-RS resource when applicable.

For a TRP-RS resource, the UE shall expect that a TCI state indicates one of the following QCL-type(s):
‘QCL-Type C’ with an SFN-SSB resource and, when applicable, ‘QCL-Type D’ with the same SFN-SSB resource, or
‘QCL-Type C’ with a non-SFN-SSB resource and, when applicable, ‘QCL-Type D’ with the same non-SFN-SSB resource.

Based on the hierarchical QCL structure 400, the UE may receive a source reference signal and based on the QCL relationship indicated by the activated TCI state to determine the parameters for transmitting or receiving a target reference signal. In one embodiment, for transmitting or receiving PDxCH DM-RS, CSI-RS, PUxCH, or SRS, the UE may receive a configuration indicating a TCI state, which specifies that the source reference signal is TRP-RS and the corresponding QCL-type, which may be QCL-Type A or QCL-Type B, and may also include QCL-Type D when applicable. In another embodiment, for receiving the TRP-RS, the UE may receive a configuration indicating a TCI state that specifies that the source reference signal is SFN-SSB or non-SFN-SSB and the corresponding QCL-type (QCL-Type C and QCL-Type D when applicable). In yet another embodiment, for transmitting PUxCH, or SRS, the UE may receive a configuration indicating a TCI state that specifies that the source reference signal is TRP-RS and the corresponding QCL-type is spatial relation when applicable.

As shown in FIG. 4, the root reference signal of the hierarchical QCL structure 400 is SSB. However, in another embodiment, if the QCL or timing relationship between SFN-SSB and TRP-RS is not available, TRP-RS may be the root reference signal of a hierarchical QCL structure.

It should be noted that in the foregoing embodiments, the hierarchical QCL structure 200 or 400 has three layers; however, the present disclosure is not limited thereto. A hierarchical QCL structure may have two or more than three layers. Irrespective of the layer number, the source and target reference signals are associated with two adjacent layers within the hierarchical QCL structure. With a hierarchical structure of QCL framework, the QCL update and indication may be more efficient.

### Illustrative Implementations

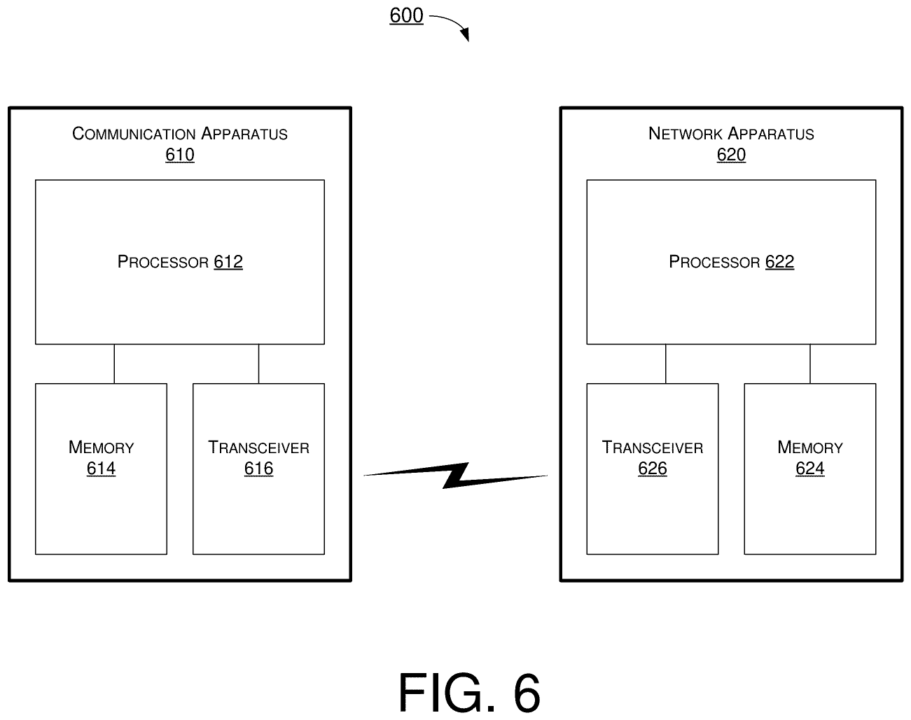

FIG. 6 illustrates an example communication system 600 having an example communication apparatus 610 and an example network apparatus 620 in accordance with an implementation of the present disclosure. Each of communication apparatus 610 and network apparatus 620 may perform various functions to implement schemes, techniques, processes and methods described herein pertaining to hierarchical QCL structure with respect to UE and network apparatus in mobile communications, including scenarios/schemes described above as well as processes 700 and 800 described below.

Communication apparatus 610 may be a part of an electronic apparatus, which may be a UE such as a portable or mobile apparatus, a wearable apparatus, a wireless communication apparatus or a computing apparatus. For instance, communication apparatus 610 may be implemented in a smartphone, a smartwatch, a personal digital assistant, a digital camera, or a computing equipment such as a tablet computer, a laptop computer or a notebook computer. Communication apparatus 610 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 610 may be implemented in a smart thermostat, a smart fridge, a smart door lock, a wireless speaker or a home control center. Alternatively, communication apparatus 610 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 610 may include at least some of those components shown in FIG. 6 such as a processor 612, for example. Communication apparatus 610 may further include one or more other components not pertinent to the proposed scheme of the present disclosure (e.g., internal power supply, display device and/or user interface device), and, thus, such component(s) of communication apparatus 610 are neither shown in FIG. 6 nor described below in the interest of simplicity and brevity.

Network apparatus 620 may be a part of a network apparatus, which may be a network node such as a satellite, a base station, a small cell, a router or a gateway. For instance, network apparatus 620 may be implemented in an eNodeB in an LTE network, in a gNB in a 5G/NR, IoT, NB-IoT or IIoT network or in a satellite or base station in a 6G network. Alternatively, network apparatus 620 may be implemented in the form of one or more IC chips such as, for example and without limitation, one or more single-core processors, one or more multi-core processors, or one or more RISC or CISC processors. Network apparatus 620 may include at least some of those components shown in FIG. 6 such as a processor 622, for example. Network apparatus 620 may further include one or more other components not pertinent to the proposed scheme of the present disclosure (e.g., internal power supply, display device and/or user interface device), and, thus, such component(s) of network apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including hierarchical QCL structure operation in a device (e.g., as represented by communication apparatus 610) and a network (e.g., as represented by network apparatus 620) in accordance with various implementations of the present disclosure.

In some implementations, communication apparatus 610 may also include a transceiver 616 coupled to processor 612 and capable of wirelessly transmitting and receiving data. In some implementations, communication apparatus 610 may further include a memory 614 coupled to processor 612 and capable of being accessed by processor 612 and storing data therein. In some implementations, network apparatus 620 may also include a transceiver 626 coupled to processor 622 and capable of wirelessly transmitting and receiving data. In some implementations, network apparatus 620 may further include a memory 624 coupled to processor 622 and capable of being accessed by processor 622 and storing data therein. Accordingly, communication apparatus 610 and network apparatus 620 may wirelessly communicate with each other via transceiver 616 and transceiver 626, respectively.

To aid better understanding, the following description of the operations, functionalities and capabilities of each of communication apparatus 610 and network apparatus 620 is provided in the context of a mobile communication environment in which communication apparatus 610 is implemented in or as a communication apparatus or a UE and network apparatus 620 is implemented in or as a network node of a communication network.

### Illustrative Processes

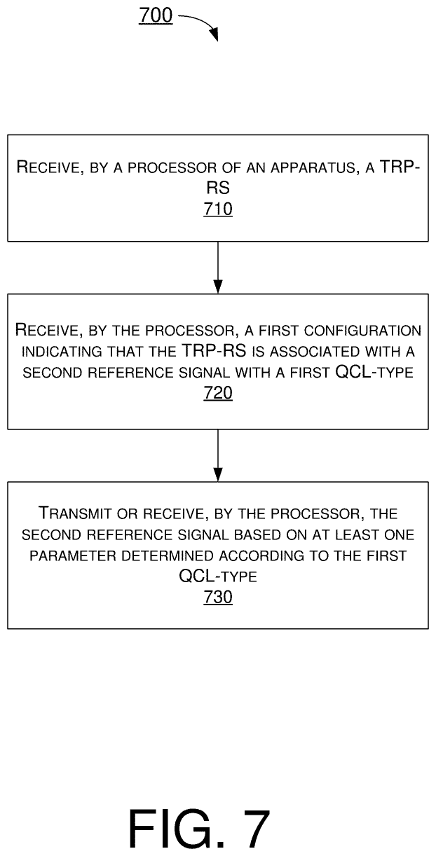

FIG. 7 illustrates an example process 700 in accordance with an implementation of the present disclosure. Process 700 may be an example implementation of above scenarios/schemes, whether partially or completely, with respect to hierarchical QCL structure of the present disclosure. Process 700 may represent an aspect of implementation of features of communication apparatus 610. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks of process 700 may be executed in the order shown in FIG. 7 or, alternatively, in a different order. Process 700 may be implemented by communication apparatus 610 or any suitable UE or machine type devices. Solely for illustrative purposes and without limitation, process 700 is described below in the context of communication apparatus 610. Process 700 may begin at block 710.

At block 710, process 700 may involve processor 612 of communication apparatus 610 receiving, via transceiver 616, a TRP-RS. Process 700 may proceed from block 710 to block 720.

At block 720, process 700 may involve processor 612 of communication apparatus 610 receiving, via transceiver 616, a first configuration indicating that the TRP-RS is associated with a second reference signal with a first QCL-type. Process 700 may proceed from block 720 to block 730.

At block 730, process 700 may involve processor 612 of communication apparatus 610 transmitting or receiving, via transceiver 616, the second reference signal based on at least one parameter determined according to the first QCL-type.

In some implementations, the second reference signal may include at least one of a PDSCH DM-RS, a PDCCH DM-RS, a CSI-RS, a PUSCH, a PUCCH, and an SRS. Process 700 may further involve processor 612 of communication apparatus 610 determining that the parameter includes a Doppler shift, a Doppler spread, an average delay, and a delay spread in an event that the first QCL-type comprises a QCL-Type A. Process 700 may further involve processor 612 of communication apparatus 610 determining that the parameter includes the Doppler shift and the Doppler spread in an event that the first QCL-type comprises a QCL-Type B. Process 700 may further involve processor 612 of communication apparatus 610 transmitting or receiving, transceiver 616, the second reference signal based on the determined parameter.

In some implementations, when the second reference signal includes any or combination of a PDSCH DM-RS, a PDCCH DM-RS, a CSI-RS, a PUSCH, a PUCCH, and an SRS, process 700 may further involve processor 612 of communication apparatus 610 determining that the parameter further comprises a spatial Rx parameter in an event that the first QCL-type further comprises a QCL-Type D.

In some implementations, the second reference signal may include at least one of a PUSCH, a PUCCH, and an SRS. Process 700 may further involve processor 612 of communication apparatus 610 determining that the parameter includes a spatial relation for UL transmission. Process 700 may further involve processor 612 of communication apparatus 610 transmitting, transceiver 616, the second reference signal based on the determined parameter.

In some implementations, process 700 may further involve processor 612 of communication apparatus 610 receiving an SSB via transceiver 616. Process 700 may further involve processor 612 of communication apparatus 610 receiving, via transceiver 616, a second configuration indicating that the SSB is associated with the TRP-RS with a second QCL-type.

In some implementations, the SSB is an SFN-SSB or a non-SFN-SSB.

In some implementations, process 700 may further involve processor 612 of communication apparatus 610 determining at least one second parameter comprising a Doppler shift and an average delay in an event that the second QCL-type comprises a QCL-Type C. Process 700 may further involve processor 612 of communication apparatus 610 receiving the TRP-RS based on the determined second parameter via transceiver 616.

In some implementations, for receiving the TRP-RS, process 700 may further involve processor 612 of communication apparatus 610 determining that the second parameter further comprises a spatial Rx parameter in an event that the second QCL-type further comprises a QCL-Type D.

In some implementations, the TRP-RS is for fine T/F tracking and/or for BM.

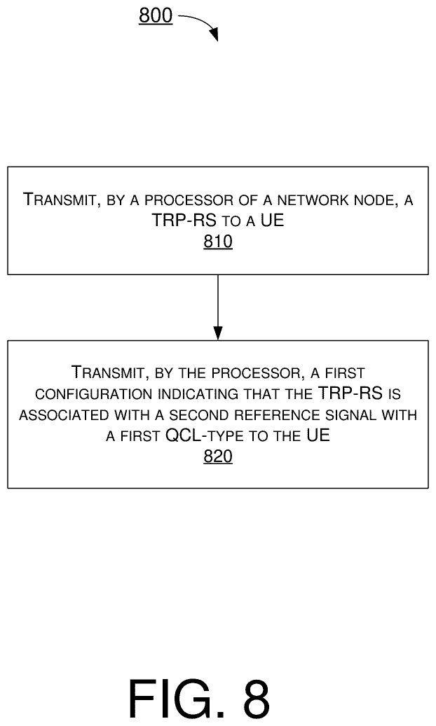

FIG. 8 illustrates another example process 800 in accordance with an implementation of the present disclosure. Process 800 may be an example implementation of above scenarios/schemes, whether partially or completely, with respect to hierarchical QCL structure in mobile communications. Process 800 may represent an aspect of implementation of features of network apparatus 620 or any suitable network node. Process 800 may include one or more operations, actions, or functions as illustrated by one or more of blocks 810 to 820. Although illustrated as discrete blocks, various blocks of process 800 may be divided into additional blocks, combined into fewer blocks, or eliminated, depending on the desired implementation. Moreover, the blocks of process 800 may be executed in the order shown in FIG. 8 or, alternatively, in a different order. Process 800 may begin at block 810.

At block 810, process 800 may involve processor 622 of network apparatus 620 transmitting, via transceiver 626, a TRP-RS to a UE (e.g., communication apparatus 610). Process 800 may proceed from block 810 to block 820.

At block 820, process 800 may involve processor 622 of network apparatus 620 transmitting, via transceiver 626, a first configuration to the UE. Specifically, the first configuration indicates that the TRP-RS is associated with a second reference signal with a first QCL-type.

In some implementations, the second reference signal includes at least one of a PDSCH DM-RS, a PDCCH DM-RS, a CSI-RS, a PUSCH, a PUCCH, and an SRS, and the first QCL-type comprises a QCL-Type A.

In some implementations, the second reference signal includes at least one of the PDSCH DM-RS, the PDCCH DM-RS, the CSI-RS, the PUSCH, the PUCCH, and the SRS, and the first QCL-type comprises a QCL-Type B.

In some implementations, the second reference signal includes at least one of the PDSCH DM-RS, the PDCCH DM-RS, the CSI-RS, the PUSCH, the PUCCH, and the SRS, and the first QCL-type comprises the QCL-Type A and a QCL-Type D.

In some implementations, the second reference signal includes at least one of the PDSCH DM-RS, the PDCCH DM-RS, the CSI-RS, the PUSCH, the PUCCH, and the SRS, and the first QCL-type comprises the QCL-Type B and the QCL-Type D.

In some implementations, the second reference signal includes at least one of the PUSCH, the PUCCH and the SRS, the first QCL-type comprises a spatial relation for UL transmission.

In some implementations, process 800 may also involve processor 622 of network apparatus 620 transmitting, via transceiver 626, an SSB to the UE, The SSB is an SFN-SSB or a non-SFN-SSB. Furthermore, process 800 may involve processor 622 of network apparatus 620 transmitting, via transceiver 626 a second configuration indicating that the SSB is associated with the TRP-RS with a second QCL-type.

In some implementations, the second QCL-type comprises a QCL-Type C.

In some implementations, the second QCL-type comprises the QCL-Type C and a QCL-Type D.

In some implementations, the TRP-RS is for fine T/F tracking and/or for BM.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a transmission reception point reference signal (TRP-RS);
receiving, by the processor, a first configuration indicating that the TRP-RS is associated with a second reference signal with a first quasi-colocation (QCL)-type; and
transmitting or receiving, by the processor, the second reference signal based on at least one parameter determined according to the first QCL-type.

2. The method of claim 1, wherein the second reference signal comprises at least one of a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS), and the transmitting or receiving of the second reference signal further comprises:
determining that the parameter comprises a Doppler shift, a Doppler spread, an average delay, and a delay spread in an event that the first QCL-type comprises a QCL-Type A;
determining that the parameter comprises the Doppler shift and the Doppler spread in an event that the first QCL-type comprises a QCL-Type B; and
transmitting or receiving the second reference signal based on the determined parameter.

3. The method of claim 2, further comprising:
determining that the parameter further comprises a spatial reception (Rx) parameter in an event that the first QCL-type further comprises a QCL-Type D.

4. The method of claim 1, wherein the second reference signal comprises at least one of a physical uplink shared channel (PUSCH), a physical uplink control channel (PUCCH), and a sounding reference signal (SRS), and the transmitting or receiving of the second reference signal further comprises:
determining that the parameter comprises a spatial relation for uplink (UL) transmission; and
transmitting the second reference signal based on the determined parameter.

5. The method of claim 1, further comprising:
receiving, by the processor, a synchronization signal block (SSB); and
receiving, by the processor, a second configuration indicating that the SSB is associated with the TRP-RS with a second QCL-type.

6. The method of claim 5, wherein the SSB is a single frequency network (SFN)-SSB or a non-SFN-SSB.

7. The method of claim 5, wherein the receiving of the TRP-RS further comprises:
determining at least one second parameter comprising a Doppler shift and an average delay in an event that the second QCL-type comprises a QCL-Type C; and
receiving the TRP-RS based on the determined second parameter.

8. The method of claim 7, further comprising:
determining that the second parameter further comprises a spatial reception (Rx) parameter in an event that the second QCL-type further comprises a QCL-Type D.

9. The method of claim 1, wherein the TRP-RS is for fine time and frequency (T/F) tracking and/or for beam measurement (BM).

10. An apparatus, comprising:
a transceiver which, during operation, communicates wirelessly; and
a processor communicatively coupled to the transceiver such that, during operation, the processor performs operations comprising:
receiving, via the transceiver, a transmission reception point reference signal (TRP-RS);
receiving, via the transceiver, a first configuration indicating that the TRP-RS is associated with a second reference signal with a first quasi-colocation (QCL)-type; and
transmitting or receiving, via the transceiver, the second reference signal based on at least one parameter determined according to the first QCL-type.

11. The apparatus of claim 10, wherein the second reference signal comprises at least one of a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS), and during operation, the processor further performs operations comprising:
determining that the parameter comprises a Doppler shift, a Doppler spread, an average delay, and a delay spread in an event that the first QCL-type comprises a QCL-Type A;
determining that the parameter comprises the Doppler shift and the Doppler spread in an event that the first QCL-type comprises a QCL-Type B; and
transmitting or receiving, via the transceiver, the second reference signal based on the determined parameter.

12. The apparatus of claim 11, wherein, during operation, the processor further performs operations comprising:
determining that the parameter further comprises a spatial reception (Rx) parameter in an event that the first QCL-type further comprises a QCL-Type D.

13. The apparatus of claim 10, wherein the second reference signal comprises at least one of a physical uplink shared channel (PUSCH), a physical uplink control channel (PUCCH), and a sounding reference signal (SRS), and during operation, the processor further performs operations comprising:
determining that the parameter comprises a spatial relation for uplink (UL) transmission; and
transmitting, via the transceiver, the second reference signal based on the determined parameter.

14. The apparatus of claim 10, wherein during operation, the processor further performs operations comprising:
receiving, via the transceiver, a synchronization signal block (SSB); and
receiving, via the transceiver, a second configuration indicating that the SSB is associated with the TRP-RS with a second QCL-type.

15. The apparatus of claim 14, wherein the SSB is a single frequency network (SFN)-SSB or a non-SFN-SSB.

16. The apparatus of claim 14, wherein during operation, the processor further performs operations comprising:
determining at least one second parameter comprising a Doppler shift and an average delay in an event that the second QCL-type comprises a QCL-Type C; and
receiving, via the transceiver, the TRP-RS based on the determined second parameter.

17. The apparatus of claim 16, wherein during operation, the processor further performs operations comprising:
determining that the second parameter further comprises a spatial reception (Rx) parameter in an event that the second QCL-type further comprises a QCL-Type D.

18. The apparatus of claim 10, wherein the TRP-RS is for fine time and frequency (T/F) tracking and/or for beam measurement (BM).

19. A method, comprising:
transmitting, by a processor of a network node, a transmission reception point reference signal (TRP-RS) to a user equipment (UE); and
transmitting, by the processor, a first configuration indicating that the TRP-RS is associated with a second reference signal with a first quasi-colocation (QCL)-type to the UE.

20. The method of claim 19, wherein:
the second reference signal comprises at least one of a physical downlink shared channel (PDSCH) demodulation reference signal (DM-RS), a physical downlink control channel (PDCCH) DM-RS, a channel state information reference signal (CSI-RS), a physical uplink shared channel (PUSCH), a physical uplink control channel (PUCCH), and a sounding reference signal (SRS), and the first QCL-type comprises a QCL-Type A;
the second reference signal comprises at least one of the PDSCH DM-RS, the PDCCH DM-RS, the CSI-RS, the PUSCH, the PUCCH, and the SRS, and the first QCL-type comprises a QCL-Type B;
the second reference signal comprises at least one of the PDSCH DM-RS, the PDCCH DM-RS, the CSI-RS, the PUSCH, the PUCCH, and the SRS, and the first QCL-type comprises the QCL-Type A and a QCL-Type D;
the second reference signal comprises at least one of the PDSCH DM-RS, the PDCCH DM-RS, the CSI-RS, the PUSCH, the PUCCH, and the SRS, and the first QCL-type comprises the QCL-Type B and the QCL-Type D; or
the second reference signal comprises at least one of the PUSCH, the PUCCH and the SRS, the first QCL-type comprises a spatial relation for uplink (UL) transmission.

21. The method of claim 19, further comprising:
transmitting, by the processor, a synchronization signal block (SSB) to the UE, wherein the SSB is a single frequency network (SFN)-SSB or a non-SFN-SSB; and
transmitting, by the processor, a second configuration indicating that the SSB is associated with the TRP-RS with a second QCL-type.

22. The method of claim 21, wherein:
the second QCL-type comprises a QCL-Type C; or
the second QCL-type comprises the QCL-Type C and a QCL-Type D.

23. The method of claim 19, wherein TRP-RS is for fine time and frequency (T/F) tracking and/or for beam measurement (BM).
